(19) United States
(12) Patent Application Publication
(10) Pub. No.: US 2016/0283815 A1
(43) Pub. Date: Sep. 29, 2016

(54) METHOD FOR DETECTING METALLIC OBJECTS

(71) Applicant: Sharper Shape Oy, Espoo (FI)

(72) Inventor: Lasse Korpela, Helsinki (FI)

(21) Appl. No.: 14/671,966

(22) Filed: Mar. 27, 2015

(51) Int. Cl. G06K 9/46; G06T 11/60; H04N 7/18; G06T 3/40; H04N 5/225; H04N 5/44; H04N 5/33; G06T 7/00

(52) U.S. Cl. CPC G06K 9/46; H04N 5/33; G06T 11/60; G06T 7/0028; G06T 3/40; H04N 5/2256; H04N 5/44; H04N 7/183; G06T 2207/20224

(57) ABSTRACT

A method of detecting metallic objects is provided. A first type of pictures is taken without an infrared flashlight. A second type of pictures is taken using an infrared flashlight. A given first type of picture and a given second type of picture are processed, wherein the given first type of picture and the given second type of picture have been taken within a time of at most 100 ms from each other. During the processing, the given first type of picture is subtracted from the given second type of picture to produce a third type of picture, and the third type of picture is used to detect metallic objects.

### TECHNICAL FIELD

The present disclosure relates generally to infrared imaging; and more specifically, to methods for detecting metallic objects using an infrared camera and an infrared flashlight. Moreover, the present disclosure relates to an apparatus for detecting metallic objects. Furthermore, the present disclosure also concerns computer program products comprising non-transitory machine-readable data storage media having stored thereon program instructions that, when accessed by a processing device, cause the processing device to execute the aforesaid methods.

### BACKGROUND

Light Detection And Ranging (LiDAR) is commonly used for aerial inspection of properties with unmanned aerial vehicles (UAVs). A problem arises when metallic objects, such as metallic roofs, vehicles, power lines and respective poles, are required to be detected and distinguished from other objects, such as forests.

### SUMMARY

The present disclosure seeks to provide an improved method for detecting metallic objects.

The present disclosure also seeks to provide an improved apparatus for detecting metallic objects.

A further aim of the present disclosure is to at least partially overcome at least some of the problems of the prior art, as discussed above.

In a first aspect, embodiments of the present disclosure provide a method for detecting metallic objects using an infrared camera and an infrared flashlight, the method comprising:

(a) taking a first type of pictures;
(b) taking a second type of pictures, using the infrared flashlight;
(c) alternating the steps (a) and (b); and
(d) processing a given first type of picture taken at the step (a) and a given second type of picture taken at the step (b), wherein the given first type of picture and the given second type of picture have been taken within a time of at most 100 ms from each other, further wherein the processing at the step (d) comprises:
(e) subtracting the given first type of picture from the given second type of picture to produce a third type of picture; and
(f) using the third type of picture for detecting metallic objects.

In a second aspect, embodiments of the present disclosure provide an apparatus comprising:

an infrared camera;
an infrared flashlight; and
a processor communicably coupled to the infrared camera, wherein the processor is configured to:

command the infrared camera to take alternately a first type of pictures and a second type of pictures, the second type of pictures being taken using the infrared flashlight; and

process a given first type of picture and a given second type of picture, which have been taken within a time of at most 100 ms from each other, by subtracting the given first type of picture from the given second type of picture to produce a third type of picture, and using the third type of picture for detecting metallic objects.

In a third aspect, embodiments of the present disclosure provide a computer program product comprising a non-transitory machine-readable data storage medium having stored thereon program instructions that, when accessed by a processing device communicably coupled to an infrared camera and an infrared flashlight, cause the processing device to:

command the infrared camera to take alternately a first type of pictures and a second type of pictures, the second type of pictures being taken using the infrared flashlight; and
process a given first type of picture and a given second type of picture, which have been taken within a time of at most 100 ms from each other, by subtracting the given first type of picture from the given second type of picture to produce a third type of picture, and using the third type of picture for detecting metallic objects.

Embodiments of the present disclosure substantially eliminate or at least partially address the aforementioned problems in the prior art, and enable easy extraction of objects with high infrared reflectivity, namely metallic objects, from objects with low infrared reflectivity, for example, such as forests.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of steps of a method for detecting metallic objects using an infrared camera and an infrared flashlight, in accordance with an embodiment of the present disclosure;

FIG. 2 is a schematic illustration of an example environment, wherein an apparatus for detecting metallic objects is implemented pursuant to an embodiment of the present disclosure; and

FIGS. 3A and 3B collectively are schematic illustrations of various components of an airborne device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

### GLOSSARY

Brief definitions of terms used throughout the present disclosure are given below.

The term “infrared camera” generally refers to a camera that is capable of capturing pictures using infrared radiation.

The term “airborne device” generally refers to a device that is airborne and is free to move.

The term “ground station” generally refers to a ground control station that is configured to control at least one airborne device. A ground station is typically located on or near the ground surface of the Earth.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the present disclosure provided herein, one of ordinary skill in the art will appreciate a variety of ways in which connection or coupling exists in accordance with the aforementioned definition.

The phrases “in an embodiment”, “in accordance with an embodiment” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

If the specification states a component or feature “may”, “can”, “could”, or “might” be included or have a characteristic, that particular component or feature is not required to be included or have the characteristic.

In a first aspect, embodiments of the present disclosure provide a method for detecting metallic objects using an infrared camera and an infrared flashlight, the method comprising:

(a) taking a first type of pictures;
(b) taking a second type of pictures, using the infrared flashlight;
(c) alternating the steps (a) and (b); and
(d) processing a given first type of picture taken at the step (a) and a given second type of picture taken at the step (b), wherein the given first type of picture and the given second type of picture have been taken within a time of at most 100 ms from each other,
further wherein the processing at the step (d) comprises:
(e) subtracting the given first type of picture from the given second type of picture to produce a third type of picture; and
(f) using the third type of picture for detecting metallic objects.

It is to be noted here that, throughout the present disclosure, the phrases “first type of picture” and “second type of picture” do not pertain to a sequence in which the given first type of picture and the given second type of picture are taken. In other words, the given first type of picture can be taken before or after the given second type of picture is taken. The difference between the first type of pictures and the second type of pictures is that the first type of pictures are taken without using the infrared flashlight and the second type of pictures are taken using the infrared flashlight. Typically, there are multiple pictures of the first type and of the second type, such as tens or hundreds of pictures of both types. A given first type of picture and a given second type of picture are taken within a time of at most 100 ms from each other. The time frame can also be shorter, such as 90, 80, 70, 60, 50, 40, 30, 20, 10, 5, 3 or 1 ms. Furthermore, the term “alternating” with respect to steps (a) and (b) is to be understood, in connection with the plural of the word “picture” in steps (a) and (b), as not being limited to taking one picture in step (a) and one picture in step (b). Indeed, step (a) may comprise taking any number of pictures, such as one, two, three, four, five, six, seven, eight, nine, ten or more and step (b) may comprise taking any number of pictures, such as one, two, three, four, five, six, seven, eight, nine, ten or more. The number of pictures taken in each step (a) and each step (b) does also not need to be the same for every sequence. For example, the method may comprise taking three pictures without using the infrared flashlight, taking two pictures using the infrared flashlight, taking two pictures without using the infrared flashlight, taking five pictures using the infrared flashlight etc.

According to an embodiment, the aforementioned method is implemented using an airborne device comprising the infrared camera and the infrared flashlight. In this embodiment, the method may be carried out during the entire flight time of the device or only during a particular flight time. The method may be also carried out as instructed by a user of the device, i.e. the apparatus as disclosed below can be switched off and on.

Typically, the airborne device is in flight while the given first type of picture and the given second type of picture are being taken. Thus, it is possible that the given first type of picture and the given second type of picture are taken from slightly different spatial positions and/or different orientations of the airborne device. Optionally, in this regard, the processing at the step (d) further comprises aligning either the given first type of picture or the given second type of picture to the other picture before performing the step (e). It is of course also possible to align both types of pictures so that they are in mutual alignment.

As an example, the aligning can be performed by using a suitable point matching algorithm. Some examples of such point matching algorithms include, but are not limited to, Iterati—ve Closest Point (ICP), Robust Point Matching (RPM), Kernel Correlation (KC), and Coherent Point Drift (CPD). Such point matching algorithms are well-known in the art, and a person skilled in the art will recognize many variations, alternatives, and modifications of embodiments of the present disclosure.

Moreover, optionally, the aligning comprises scaling either the given first type of picture or the given second type of picture to a scale of the other picture. Again, both types of pictures can be scaled to a third scale, different from the scale of both the first type of picture and the second type of picture. A point matching algorithm may also be used for this purpose, and the method may also comprise using one or more keypoints.

According to an embodiment, the step (f) is performed using Hough transform. Optionally, in this regard, the third type of picture is analyzed using a suitable variant or extension of classical Hough transform, for example, such as Generalized Hough Transform (GHT) and Randomized Hough Transform (RHT). It is to be noted here that the step (f) is not limited to Hough transform, and can be performed using other suitable algorithms. A person skilled in the art will recognize many variations, alternatives, and modifications of embodiments of the present disclosure.

The method may also be carried out using two cameras, one infrared camera and one camera equipped with a RGB (red-green-blue) filter, or any other type of filter (provided the camera is different from infrared camera). The use of two cameras, one for step (a) and another for step (b) would also allow to shorten the lapse of time between the two types of pictures, as the two types of pictures could be taken virtually at the same time. The other steps could then be carried out as explained above and below. Hence the apparatus would then also comprise a second camera, as defined above.

Furthermore, according to an embodiment, the method further comprises communicating spatial positions of the airborne device and a detected metallic object to a ground station. Optionally, in this regard, the spatial position of the airborne device is determined by a Global Navigation Satellite System (GNSS) unit of the airborne device, while an orientation of the airborne device is determined by an Inertial Measurement Unit (IMU) of the airborne device. The spatial position of the detected metallic object is then determined with respect to the spatial position and the orientation of the airborne device.

According to an embodiment, the method further comprises guiding the airborne device using information about the detected metallic object. Optionally, in this regard, a direction of flight of the airborne device is adjusted based on the orientation of the detected metallic object.

As an example, when the detected metallic object is a power line, the airborne device can be guided to fly along an aerial route from where the power line can be monitored. As another example, when the detected metallic object is a metallic roof, the airborne device can be guided to fly around a building having the metallic roof.

According to an embodiment, the detected metallic object is selected from the group consisting of a metallic roof, a power line, a power line pole, a vehicle, an antenna and a chimney. It is to be noted here that, throughout the present disclosure, the term “metallic object” encompasses metallic objects that are coated with non-metallic materials. As an example, power lines are often coated with non-metallic materials to protect them from environmental damage.

An advantage of using the infrared flashlight is that infrared light penetrates non-metallic materials, and thus enables detection of even those metallic objects that are coated with non-metallic materials. Moreover, infrared light penetrates dust and gas much better than visible light. Thus, infrared light enables an efficient detection of metallic objects.

Embodiments of the present disclosure are susceptible to being used for various purposes, including, though not limited to, enabling easy extraction of objects with high infrared reflectivity, namely metallic objects, from objects with low infrared reflectivity, for example, such as forests.

For illustration purposes only, there will now be considered an example implementation of the aforementioned method with an airborne device comprising an infrared camera and an infrared flashlight pursuant to embodiments of the present disclosure.

An example operation loop includes the following steps:

Step 1: A first type of picture is taken without an infrared flash, while a second type of picture is taken with an infrared flash.

Step 2: Either the first type of picture or the second type of picture is aligned to the other picture.

Step 3: The first type of picture is subtracted from the second type of picture to produce a third type of picture.

Step 4: The third type of picture is analysed for detecting possible metallic objects.

Step 5: When a metallic object is detected, an orientation of the detected metallic object is determined with respect to a spatial position and an orientation of the airborne device at a time when the first type of picture and the second type of picture were taken. Optionally, the orientation of the detected metallic object is normalized.

Step 6 (optional): The orientation of the detected metallic object is used to adjust a direction of flight of the airborne device.

Step 7: Orientation data is stored. Optionally, the orientation data includes at least one of: the orientation of the detected metallic object, the spatial position of the airborne device, the orientation of the airborne device, and an associated time-stamp.

The example operation loop is repeated for other pairs of a first type of pictures and a second type of pictures. It will be appreciated that the example operation loop can be repeated substantially continuously. For illustration purposes only, there will now be considered an example where a first type of pictures and a second type of pictures are taken in a following order:

A1, B1, A2, B2, A3, B3.

In the example herein, ‘A’ denotes the first type of pictures, while ‘B’ denotes the second type of pictures.

A third type of pictures is then produced as follows:

C1=B1−A1

C2=B2−A2

C3=B3−A3

where ‘C’ denotes the third type of pictures.

Thus, for each pair of the first type of pictures and the second type of pictures, a corresponding third type of picture is produced. As a result, the number of the third type of pictures is the same as the number of the first type of pictures and the number of the second type of pictures.

Some practical values for the present disclosure are for example the following. An exposure time for visible light is typically about 1/4000- 1/500, i.e. less than 2 ms. An exposure time for infrared light is approximately half of that of the visible light, about 1/2000- 1/250, i.e. less than 1 ms. Naturally, inaccuracy of the picture increases if the exposure time is too long, for example over 1/500. The processing step (d) can be performed frequently, for example up to 5 processes per second.

In a second aspect, embodiments of the present disclosure provide an apparatus comprising:

an infrared camera;
an infrared flashlight; and
a processor communicably coupled to the infrared camera, wherein the processor is configured to:

command the infrared camera to take alternately a first type of pictures and a second type of pictures, the second type of pictures being taken using the infrared flashlight; and

process a given first type of picture and a given second type of picture, which have been taken within a time of at most 100 ms from each other, by subtracting the given first type of picture from the given second type of picture to produce a third type of picture, and using the third type of picture for detecting metallic objects.

According to an embodiment, the processor is configured to align either the given first type of picture or the given second type of picture to the other picture, before subtracting the given first type of picture from the given second type of picture.

According to an embodiment, the apparatus further comprises a data storage for storing information. Optionally, the data storage is used to store the first set of pictures and the second set of pictures along with associated time-stamps.

Optionally, the data storage is used to store orientation data for each detected metallic object, wherein the orientation data includes an orientation of that detected metallic object with respect to a spatial position and an orientation of the apparatus, and an associated time-stamp. For this purpose, optionally, the apparatus further comprises a GNSS unit for determining its own spatial position and an IMU for determining its own orientation.

According to an embodiment, the apparatus is implemented by way of an airborne device. Optionally, the airborne device is selected from the group consisting of a helicopter, a multi-copter, a fixed-wing aircraft, a harrier and an unmanned aerial vehicle.

Optionally, the processor is configured to guide the airborne device using information about detected metallic objects. Optionally, in this regard, the processor is configured to adjust a direction of flight of the airborne device based on the orientation of the detected metallic objects.

According to an embodiment, the apparatus further comprises a wireless communication interface for communicating with a ground station. In an example, the wireless communication interface could be a radio communication interface.

Optionally, the processor is configured to use the wireless communication interface to receive control instructions from the ground station, for example, including instructions and/or information pertaining to a planned aerial route to be traversed by the airborne device.

Optionally, the processor is configured to use the wireless communication interface to send the orientation data for each detected metallic object to the ground station. Alternatively, optionally, the orientation data is stored at the data storage, and is downloaded to a processing device of the ground station when the airborne device lands on the ground station.

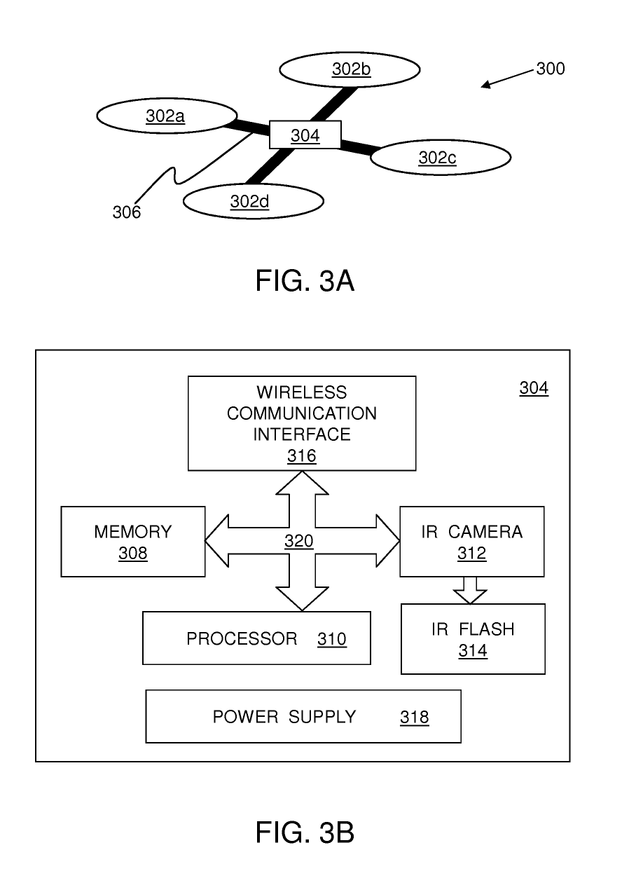

Furthermore, an example airborne device has been illustrated in conjunction with FIGS. 3A and 3B as explained in more detail below. In accordance with an embodiment of the present disclosure, an airborne device includes at least one propeller, wherein each propeller includes its associated motor unit for driving that propeller. The airborne device also includes a main unit that is attached to the at least one propeller by at least one arm. It is to be noted here that the airborne device could alternatively be implemented by way of miniature helicopters, miniature multi-copters, miniature fixed-wing aircrafts, miniature harriers, or other unmanned aerial vehicles.

The main unit includes, but is not limited to, a data memory, a computing hardware such as a processor, an infrared camera, an infrared flashlight, a wireless communication interface, a power source, and a system bus that operatively couples various sub-components of the main unit including the data memory, the processor, the infrared camera, and the wireless communication interface.

The power source supplies electrical power to various components of the airborne device, namely, the at least one propeller and the various sub-components of the main unit.

Optionally, the power source includes a rechargeable battery, for example, such as a Lithium-ion battery. The battery may be recharged or replaced, when the airborne device lands, for example, on a landing platform of a ground station.

The data memory optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

Optionally, the infrared flashlight is a separate unit that is mounted on the infrared camera. Alternatively, optionally, the infrared flashlight is built directly into the infrared camera.

The processor is configured to command the infrared camera to take alternately a first type of pictures and a second type of pictures, the second type of pictures being taken using the infrared flashlight.

The infrared flashlight is operable to emit infrared radiation. Some of the emitted infrared radiation is reflected back from possible metallic objects to the infrared camera, which then captures corresponding second type of pictures.

Moreover, the processor is configured to process a given first type of picture and a given second type of picture, which have been taken within a time of at most 100 ms from each other, by subtracting the given first type of picture from the given second type of picture to produce a third type of picture, and using the third type of picture for detecting metallic objects.

Moreover, optionally, the airborne device further includes a configuration of sensors that includes at least one of: an IMU, a GNSS unit, an altitude meter, a magnetometer, an accelerometer, and/or a gyroscopic sensor.

Optionally, a GNSS unit included in the configuration of sensors is employed to determine absolute spatial positions of the airborne device upon a surface of the Earth when taking the first and second types of pictures. Additionally, optionally, an IMU included in the configuration of sensors is employed to determine orientations of the airborne device when taking the first and second types of pictures.

Moreover, the processor is configured to use the wireless communication interface for communicating with a ground station.

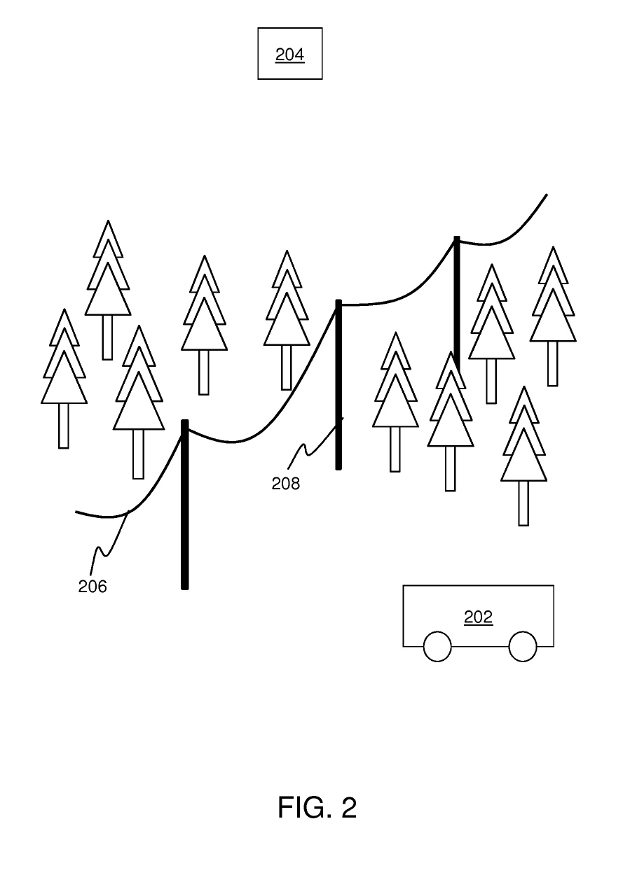

For illustration purposes only, there will now be considered an example environment, wherein the aforementioned apparatus is implemented pursuant to embodiments of the present disclosure. One such example environment has been illustrated in conjunction with FIG. 2 as explained in more detail below.

In the example environment, a ground station is installed at a certain geographical position that is surrounded by a forest. It will be appreciated that the ground station can be installed in various ways. In an example, the ground station can be installed on a vehicle, such as a car, a truck, an all-terrain vehicle, a snow mobile and the like. In another example, the ground station can be installed on the ground surface of the Earth, a bridge or any suitable infrastructure.

In the example herein, let us consider that it is desirable to detect and monitor a power line passing through the forest. For this purpose, at least one airborne device is configured to fly along a planned aerial route in the surroundings of the ground station.

The at least one airborne device includes, inter alia, an infrared camera, an infrared flashlight, and a computing hardware, such as a processor.

The processor is configured to command the infrared camera to take alternately a first type of pictures and a second type of pictures, the second type of pictures being taken using the infrared flashlight. Moreover, the processor is configured to process a given first type of picture and a given second type of picture, which have been taken within a time of at most 100 ms from each other, by subtracting the given first type of picture from the given second type of picture to produce a third type of picture, and using the third type of picture for detecting metallic objects.

Thus, the aforementioned apparatus enables easy extraction of objects with high infrared reflectivity, such as the power line and associated poles, from objects with low infrared reflectivity, such as the forest.

In a third aspect, embodiments of the present disclosure provide a computer program product comprising a non-transitory machine-readable data storage medium having stored thereon program instructions that, when accessed by a processing device communicably coupled to an infrared camera and an infrared flashlight, cause the processing device to:

command the infrared camera to take alternately a first type of pictures and a second type of pictures, the second type of pictures being taken using the infrared flashlight; and
process a given first type of picture and a given second type of picture, which have been taken within a time of at most 100 ms from each other, by subtracting the given first type of picture from the given second type of picture to produce a third type of picture, and using the third type of picture for detecting metallic objects.

According to an embodiment, when accessed by the processing device, the program instructions cause the processing device to align either the given first type of picture or the given second type of picture to the other picture, before subtracting the given first type of picture from the given second type of picture.

### DETAILED DESCRIPTION OF DRAWINGS

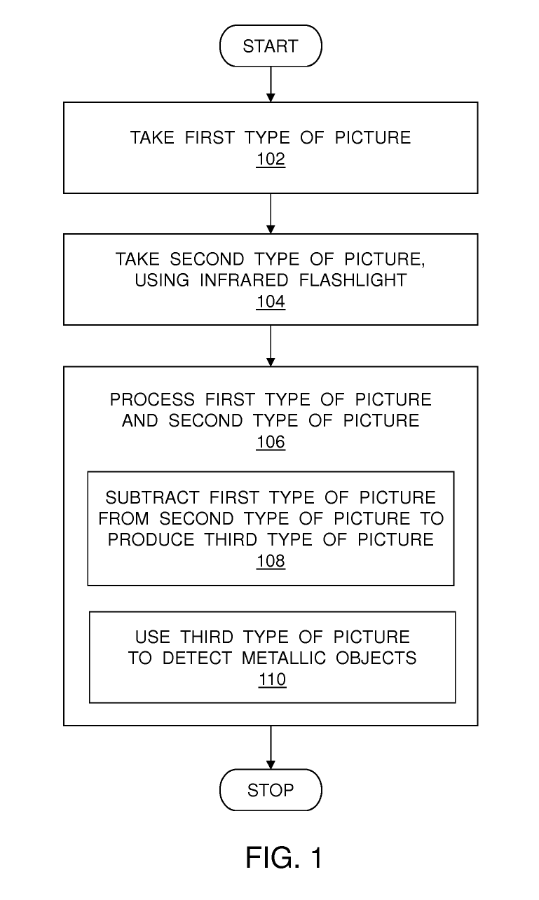

Referring now to the drawings, particularly by their reference numbers, FIG. 1 is an illustration of steps of a method for detecting metallic objects using an infrared camera and an infrared flashlight, in accordance with an embodiment of the present disclosure. The method is depicted as a collection of steps in a logical flow diagram, which represents a sequence of steps that can be implemented in hardware, software, or a combination thereof.

At a step 102, a first type of pictures is taken.

At a step 104, a second type of pictures is taken, using the infrared flashlight. These steps are typically repeated several times.

At a step 106, a given first type of picture taken at the step 102 and a given second type of picture taken at the step 104 are processed, wherein the given first type of picture and the given second type of picture have been taken within a time of at most 100 ms from each other.

The step 106 includes steps 108 and 110. At the step 108, the given first type of picture is subtracted from the given second type of picture to produce a third type of picture. Subsequently, at the step 110, the third type of picture is used to detect metallic objects.

The steps 102 and 104 are performed alternately. In this regard, the step 106 is performed for each pair of the first type of pictures and the second type of pictures that have been taken within a time of at most 100 ms from each other.

The steps 102 to 110 are only illustrative and other alternatives can also be provided where one or more steps are added, one or more steps are removed, or one or more steps are provided in a different sequence without departing from the scope of the claims herein.

FIG. 2 is a schematic illustration of an example environment, wherein an apparatus for detecting metallic objects is implemented pursuant to an embodiment of the present disclosure.

In the example environment, a ground station 202 is installed at a geographical position that is surrounded by a forest, and the apparatus is implemented by way of an airborne device 204 that is configured to fly in the surroundings of the ground station 202. The airborne device 204 is configured to communicate with the ground station 202 wirelessly.

With reference to FIG. 2, a power line 206 passes through the forest. The power line 206 is supported by poles 208.

The airborne device 204 is configured to detect the power line 206 and the poles 208, as described earlier.

FIG. 2 is merely an example, which should not unduly limit the scope of the present disclosure. A person skilled in the art will recognize many variations, alternatives, and modifications of embodiments of the present disclosure.

FIGS. 3A and 3B collectively are schematic illustrations of various components of an airborne device 300, in accordance with an embodiment of the present disclosure. The airborne device 300 includes at least one propeller, depicted as a propeller 302a, a propeller 302b, a propeller 302c and a propeller 302d in FIG. 3A (hereinafter collectively referred to as propellers 302).

The airborne device 300 also includes a main unit 304 that is attached to the propellers 302 by arms 306.

With reference to FIG. 3B, the main unit 304 includes, but is not limited to, a data memory 308, a computing hardware such as a processor 310, an infrared camera 312, an infrared flashlight 314, a wireless communication interface 316, a power source 318 and a system bus 320 that operatively couples various components including the data memory 308, the processor 310, the infrared camera 312 and the wireless communication interface 316.

FIGS. 3A and 3B are merely examples, which should not unduly limit the scope of the claims herein. It is to be understood that the specific designation for the airborne device 300 is provided as an example and is not to be construed as limiting the airborne device 300 to specific numbers, types, or arrangements of modules and/or components of the airborne device 300. A person skilled in the art will recognize many variations, alternatives, and modifications of embodiments of the present disclosure. It is to be noted here that the airborne device 300 could be implemented by way of miniature helicopters, miniature multi-copters, miniature fixed-wing aircrafts, miniature harriers, or other unmanned aerial vehicles.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method for detecting metallic objects using an infrared camera and an infrared flashlight, the method comprising:
(a) taking a first type of pictures;
(b) taking a second type of pictures, using the infrared flashlight;
(c) alternating the steps (a) and (b); and
(d) processing a given first type of picture taken at the step (a) and a given second type of picture taken at the step (b), wherein the given first type of picture and the given second type of picture have been taken within a time of at most 100 ms from each other, further wherein the processing at the step (d) comprises:
(e) subtracting the given first type of picture from the given second type of picture to produce a third type of picture; and
(f) using the third type of picture for detecting metallic objects.

2. The method according to claim 1, wherein the step (f) is performed using Hough transform.

3. The method according to claim 1, wherein the processing at the step (d) further comprises aligning either the given first type of picture or the given second type of picture to the other picture before performing the step (e).

4. The method according to claim 3, wherein the aligning comprises scaling either the given first type of picture or the given second type of picture to a scale of the other picture.

5. The method according to claim 1, wherein the method is implemented using an airborne device comprising the infrared camera and the infrared flashlight.

6. The method according to claim 5, further comprising communicating spatial positions of the airborne device and a detected metallic object to a ground station.

7. The method according to claim 6, further comprising guiding the airborne device using information about the detected metallic object.

8. The method according to claim 6, wherein the detected metallic object is selected from the group consisting of a metallic roof, a power line, a power line pole, a vehicle, an antenna and a chimney.

9. An apparatus comprising:
an infrared camera;
an infrared flashlight; and
a processor communicably coupled to the infrared camera, wherein the processor is configured to:
command the infrared camera to take alternately a first type of pictures and a second type of pictures, the second type of pictures being taken using the infrared flashlight; and
process a given first type of picture and a given second type of picture, which have been taken within a time of at most 100 ms from each other, by subtracting the given first type of picture from the given second type of picture to produce a third type of picture, and using the third type of picture for detecting metallic objects.

10. The apparatus according to claim 9, wherein the processor is configured to align either the given first type of picture or the given second type of picture to the other picture, before subtracting the given first type of picture from the given second type of picture.

11. The apparatus according to claim 9, further comprising a data storage for storing information.

12. The apparatus according to claim 9, wherein the apparatus is implemented by way of an airborne device.

13. The apparatus according to claim 12, further comprising a wireless communication interface for communicating with a ground station.

14. The apparatus according to claim 12, wherein the airborne device is selected from the group consisting of a helicopter, a multi-copter, a fixed-wing aircraft, a harrier and an unmanned aerial vehicle.

15. A computer program product comprising a non-transitory machine-readable data storage medium having stored thereon program instructions that, when accessed by a processing device communicably coupled to an infrared camera and an infrared flashlight, cause the processing device to:
command the infrared camera to take alternately a first type of pictures and a second type of pictures, the second type of pictures being taken using the infrared flashlight; and
process a given first type of picture and a given second type of picture, which have been taken within a time of at most 100 ms from each other, by subtracting the given first type of picture from the given second type of picture to produce a third type of picture, and using the third type of picture for detecting metallic objects.

16. The computer program product according to claim 15, wherein when accessed by the processing device, the program instructions cause the processing device to align either the given first type of picture or the given second type of picture to the other picture, before subtracting the given first type of picture from the given second type of picture.
